(19) United States
(12) Patent Application Publication
(10) Pub. No.: US 2009/0251393 A1
(43) Pub. Date: Oct. 8, 2009

(54) SCALABLE LED DISPLAY SYSTEM

(76) Inventor: Chen-Tung Fan, Jhudong Chen (TW)

Correspondence Address: Rabin & Berdo, P.C.;Suite 500, 1101 14th Street, Washington, DC, 20005, US

(21) Appl. No.: 12/062,677

(22) Filed: Apr. 4, 2008

(51) Int. Cl. G09G 3/32

(52) U.S. Cl. 345/82; 345/84

(57) ABSTRACT

The scalable LED display system has multiple scalable pre-assembled display blind panels to construct a display screen to meet the customer demands of various display sizes. An image controlling device is electronically connected to the LED display screen to drive the LED display screen. Therefore, the present invention simplifies the wiring from an image controlling device to thousands or millions of LED chips of the display screen, resulting in the simplification of the wiring and savings in time and effort for assembly, disassembly, and installation of the display system.

### BACKGROUND OF THE INVENTION

1. Field of the Invention

The invention relates to a Light Emitting Diode (LED) display system, and more particularly to a scalable LED display system the use of multiple scalable pre-assembled building blocks to construct the display system for various display size needs, which results in significant savings in time and effort required for scalability, transportation, installation, assembly, disassembly, troubleshooting and repair of the display system.

2. Description of the Related Art

A conventional display system is often used for advertising, architectural, stage and theatrical applications. The conventional display system comprises two major parts: a display screen and a control system. The display screen is generally constructed with LED chips mounted on a flat panel supported by a metal frame. These LED chips are arranged at geometrically predetermined positions in a grid or matrix. Each pixel, the cross point of the grid, comprises three LED chips in red, green or blue colors that will illuminate to project lights in the full color spectrum. Therefore, the display screen with thousands or millions of pixels illuminating in various colors and brightness will present still images or animated images. The control system contains a control circuitry and a power supply used to drive the LED chips to illuminate various colors and brightness.

The heavy, rigid and bulky construction of the display screen, the support panel and the metal frame make them inflexible to fit to different scales or sizes and difficult to be transported, assembled, disassembled, erected and removed.

### SUMMARY OF THE INVENTION

An object of the present invention is to provide a scalable LED display system that provides multiple pre-assembled scalable display blind panels to construct a display screen to meet the customer demands of various display sizes.

A second object of the present invention is to simplify the wiring from an image controlling device to thousands or millions of LED chips of the display screen, resulting in the simplification of the wiring and the savings in time and effort for assembly, disassembly, and installation of the display system.

A third object of the present invention is to simplify the complexity of troubleshooting and repair by quickly isolating the trouble (or troubles) to a specific building block (or blocks) and thereafter either replacing the entire building block or focusing on the diagnostic of that specific building block.

Therefore, the scalable LED display system in accordance with the present invention comprises the LED display screen and the image controlling device. The LED display screen has multiple pre-assembled scalable display blind panels. The image controlling device is electronically connected to the LED display screen to drive the LED display screen.

Based on the foregoing description, since the LED display screen is assembled by the multiple pre-assembled scalable display blind panels, the LED display screen may have various sizes by expanding the screens either vertically or horizontally or both.

### BRIEF DESCRIPTION OF THE DRAWINGS

FIG. 1 is a perspective view of a scalable LED display system in accordance with the present invention;

FIG. 2 is an exploded view in partial of the scalable LED display system in accordance with the present invention;

FIG. 3 is an exploded view in partial of the scalable LED display system in accordance with the present invention;

FIG. 4 is an exploded view in partial of a pixel-display string in accordance with the present invention;

FIG. 5 is a circuit diagram of a controlling circuit of each display blind module in accordance with the present invention;

FIG. 6 is a line arrangement diagram in accordance with the present invention; and

FIG. 7 is a time sequence waveform diagram in accordance with the present invention.

### DETAILED DESCRIPTION OF THE INVENTION

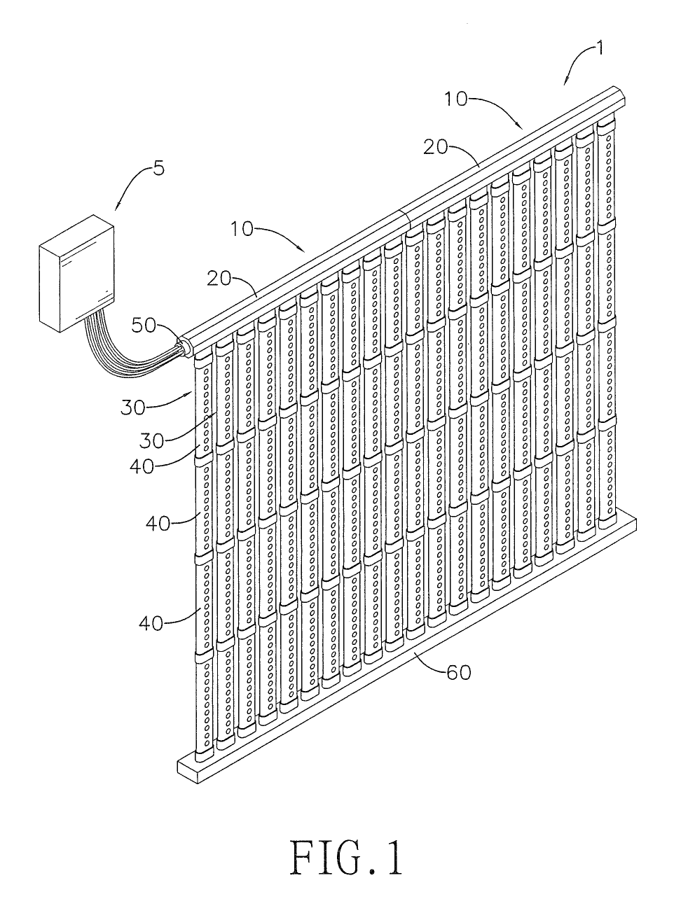

Referring to FIG. 1, a scalable LED display system of a preferred embodiment in accordance with the present invention has an LED display screen 1 and an image controlling device 5 electronically connected to the LED display screen 1. The LED display screen 1 comprises multiple pre-assembled display blind panels 10. Since each display blind panel 10 is previously assembled by multiple pixel-display strings 30 and each pixel-display string 30 comprises multiple display blind modules 40, a size of the LED display screen 1 is easily expanded vertically or horizontally or both.

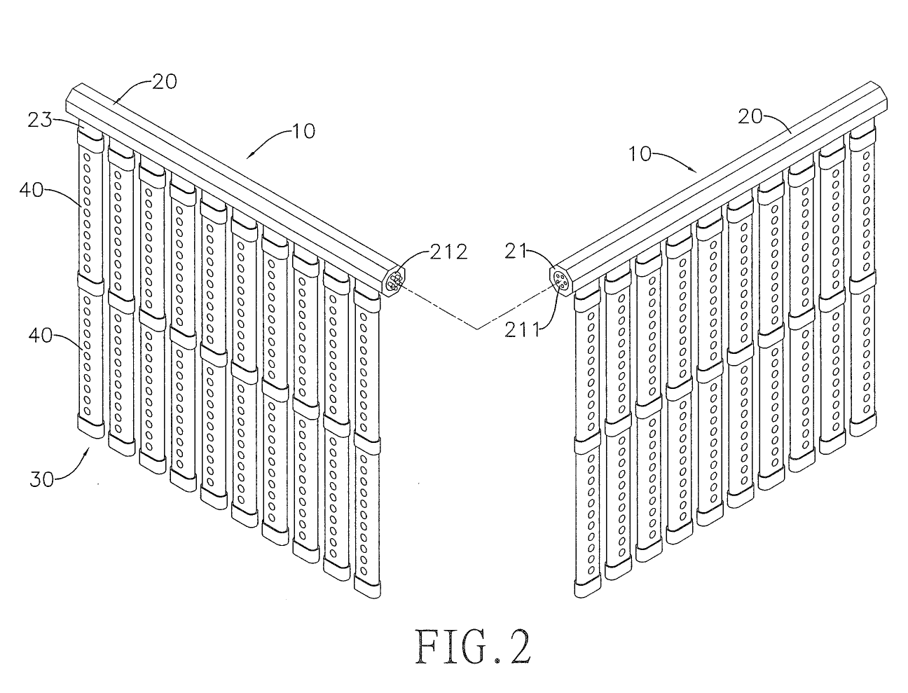

Referring to FIG. 2, a preferred embodiment of the LED display screen 1 comprises two display blind panels 10 that are horizontally assembled together. Each display blind panel 10 has a top beam 20, multiple pixel-display strings 30 and an optional reinforce fixer 60. Two ends of each of the pixel-display strings 30 are assembled between the top beam 20 and the reinforce fixer 60, and the pixel-display strings 30 are parallel between the top beam 20 and the reinforce fixer 60. The image controlling device 5 is only electronically connected to one end of one top beam 20 of the LED display screen 1.

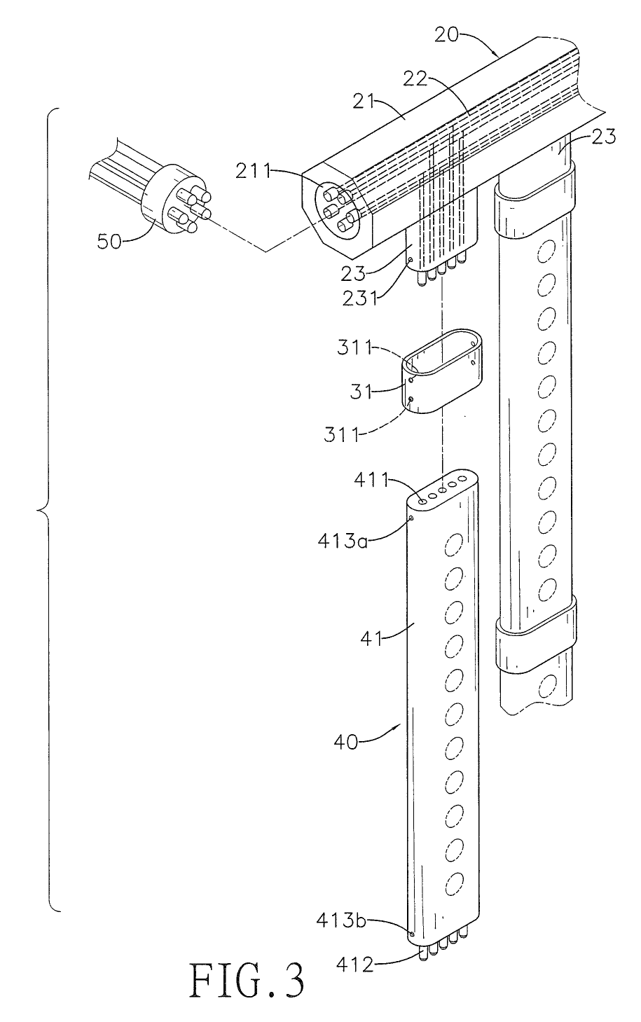

Referring to FIG. 3, when the LED display system is assembled on a location such as a wall, the top beam 20 is securely fastened to a physical structure frame.

The top beam 20 has a long pipe 21, five wires 22 and multiple output interface ports 23. The long pipe 21 has a jack 211 and a plug 212 respectively at one end thereof. The jack 211 is mounted to one end of the top beam 20 and the plug 212 is mounted to the other end of the top beam 20. Since the image controlling device 5 has a connector 50 to plug into the jack 211 of the top beam 20, the image controlling device 5 generates controlling signals and supplies power to the top beam through the connector 50 and the jack 211. Therefore, a user can easily assemble the image controlling device 5 and the top beam 20.

Five wires 22 are mounted inside of the long pipe 21 and connected between the jack 211 and plug 212. The wires 22 includes controlling signal wires and power wires, so the wires 22 are used to transmit the controlling signals and power from the image controlling device 5.

The output interface ports 23 are mounted on an outside of the long pipe 21 in a line and are respectively and electronically connected to the wires 22. Therefore, each output interface port 23 transmits the controlling signals and supplies the power.

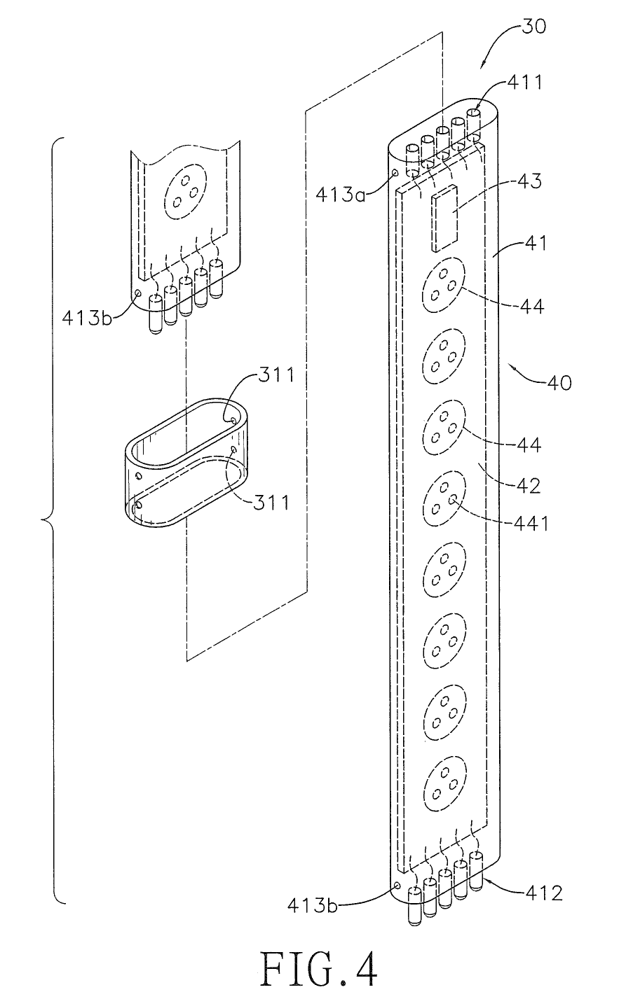

Referring to FIGS. 3 and 4, each of the pixel-display strings 30 has at least one display blind module 40. The display blind modules 40 of each pixel-display strings 30 are mounted in series and electronically connected with each other. Each display blind module 40 has a long casing 41, a jack 411, a plug 412, a print circuit board (PCB) 42, a controlling circuit 43 and multiple LED unit 44.

The casing 41 has two opposite ends and is made of transparent material. The jack 411 is mounted to a top of the casing 41 and the plug 412 is mounted on a bottom of the casing 41. Referring to FIG. 3, a top display blind module 40 of one pixel-display string 30 is connected to the corresponding output interface port 23 of the top beam 20. That is, the output interface port 23 plugs into the jack 411 of the top pixel-display string 30, so the controlling signals and power are supplied to the top pixel-display string 30. Therefore, the pixel-display strings 30 are easily assembled to the top beam 20.

Referring to FIG. 4, the PCB 42 is mounted inside the casing 41 and electronically connected to the jack 411 and the plug 412. The controlling circuit 43 is electronically mounted on the PCB 42, and LED units 44 are electronically connected to the controlling circuit 43. Therefore, when the controlling signals and power from the image controlling device 5 are supplied to the controlling circuit 43, the controlling circuit 43 drives the LED sets 44. The controlling circuit 43 drives the LED units 44 to emit lights of different brightness and different colors since each LED unit 44 consists of multiple LED chips 441 with different colors. The lights of the LED units 44 pass through the casing 41. The LED units 44 are mounted on the PCB 42 to electronically connect to the controlling circuit 43 through the PCB 42. The LED units 44 are not necessarily to be commonly configured on the PCB 42, each of the LED units 44 can also be of a single form to be respectively configured on the long casing 41.

When all display blind modules 40 are plugged together, the top display blind module 40 transmits controlling signals and power to other display blind modules 40 of the same the pixel-display string 30. Therefore, a user can easily assemble all display blind modules 40 in series to construct a pixel-display string 30.

Furthermore, to connect the display blind modules 40 together easily and strongly, the pixel-display string 30 is provided with multiple rings 31, please referring to FIGS. 3 and 4. Since each pixel-display string 30 has multiple display blind modules 40, one ring 31 is required to connect the two adjacent display blind module 40 or between the top beam 20 and the top display blind module 40 of each pixel-display string 30. In this preferred embodiment, the output interface port 23 has two protrusions 231. When the output interface port 23 plugs into the corresponding jack 411 of the top display blind module 40 of the corresponding pixel-display string 30, the ring 31 is mounted around a joint between the output interface port 23 and the top display blind module 40. The two protrusions 231 of the output interface port 23 are fixed in two recesses 311 inside of the ring 31, and two protrusions 413 a formed outside the top display blind module 40 are fixed in other two recesses 311 inside the ring 31.

When the plug 412 of the casing 41 of the display blind module 40 plugs into the jack 411 of the adjacent display blind module 40, the ring 31 is mounted around a joint between the two adjacent display blind modules 40 of the pixel-display strings 30. The two protrusions 413b of the upper display blind module 40 are fixed in two recesses 311 inside of the ring 31, and the two protrusions 413a of the lower display blind module 40 are fixed in other two recesses 311.

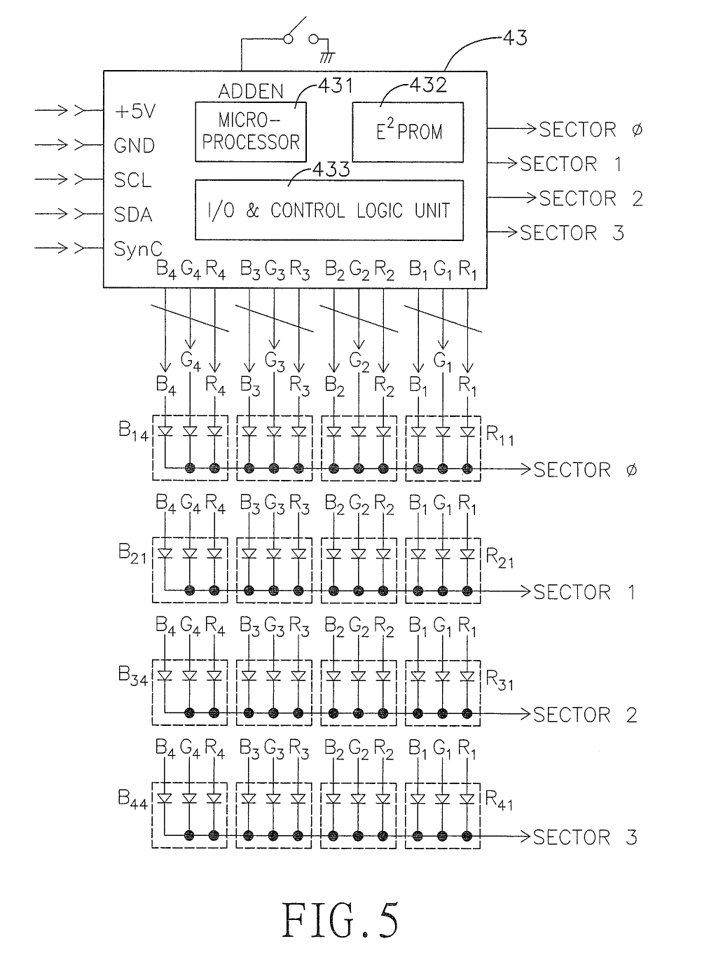

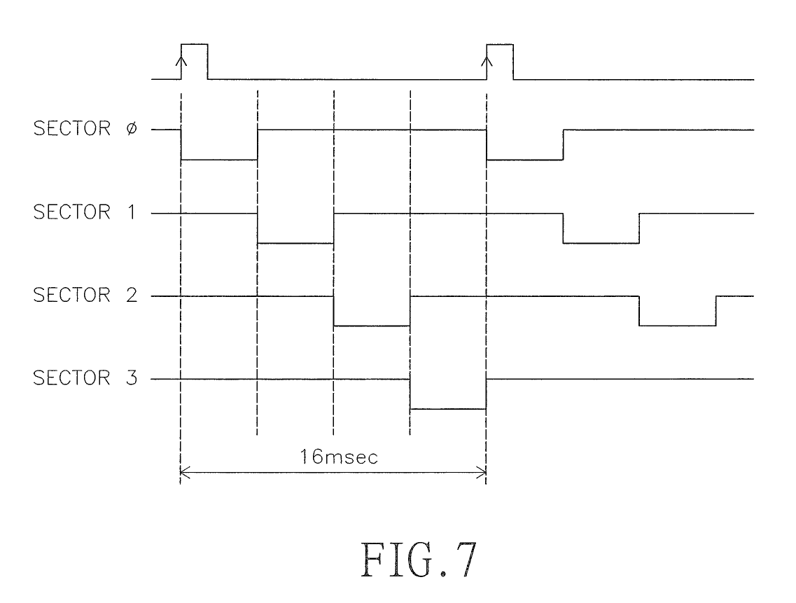

Referring to FIG. 5, an electronic connection relationship of the controlling circuit 43 and multiple LED units 44 is shown. In this preferred embodiment, the display blind module 40 has sixteen LED units 44. The controlling circuit 43 includes a microprocessor 431, an EEPROM 432, an I/O and control logic unit 433, multiple controlling signal pins (SCL, SDA and Sync), power pins (+5V, GND), four output ports (B1G1R1 to B4R4G4) and four control pins (SECTOR 0 to SECTOR 3) to form a time sharing matrix drive. Each of the output port (B1G1R1 to B4R4G4) has three output terminals to control red light, green light and blue light LED chips respectively. The SCL line is a clock line and the SDA line is a data line, so the two lines transmits all the necessary displaying controlling information (such as brightness, duration etc.) from the image controlling device 5 by using a serial transmission protocol. The Sync pin is used to transmit a synchronization signal to drive the controlling circuit 43 to work at a proper timing. Referring to FIG. 7, the four control pins (SECTOR 0 to SECTOR 3) alternately drive the LED units 44 in a scanning manner.

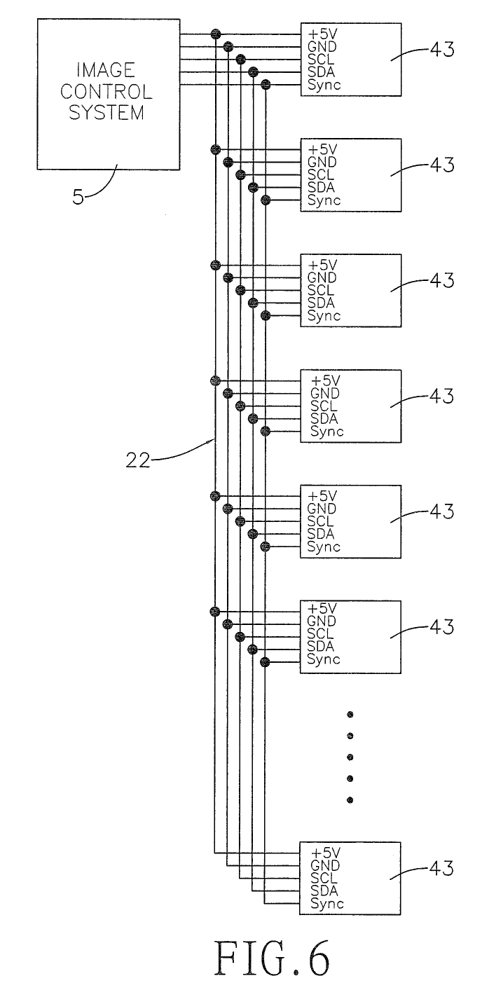

When multiple top display blind modules 40 are assembled to the top beam 20, an electronic connection between the image controlling device 5 and multiple controlling circuits 43 of the top display blind modules 40 is shown in FIG. 6. The image controlling device 5 also uses control signals as a synchronous display control for all of the display blind modules 40, so that the controlling circuit 43 controls the brightness and colors of the LED units 44 of the display blind modules 40 to generate a designated image or words.

The aforesaid preferred embodiment has multiple display blind modules 40 to form one pixel-display strings 30. However, in practical application the pixel-display strings 30 also can be formed by only one single display blind module 40.

Since the scalable LED display system has multiple pre-assembled scalable display blind panels 10 to construct an LED display screen 1 to meet the customer demands of various display sizes, and the image controlling device 5 is electronically connected to the LED display screen to drive the LED display screen, the present invention therefore simplifies the wiring from an image controlling device 5 to thousands or millions of LED chips 441 of the LED display screen, resulting in also the savings in time and effort for assembly, disassembly, and installation of the display system.

While the invention has been described by way of example and in terms of a preferred embodiment, it is to be understood that the invention is not limited therewith. On the contrary, it is intended to cover various modifications and similar arrangements and procedures, and the scope of the appended claims therefore should be accorded with the broadest interpretation so as to encompass all such modifications and similar arrangements and procedures.

What is claimed is:

1. A scalable LED display system, comprising:
an image controlling device for generating controlling signals and power; and
an LED display screen for being electronically connected to the image controlling device and assembled by multiple display blind panels horizontally, wherein each display blind panel comprises a top beam and multiple pixel-display strings connected to the top beam in parallel.

2. The scalable LED display system as claim in claim 1, wherein
the image controlling device has a connector;
the top beam comprises:
a long pipe having:
two ends;
a jack mounted to one end and connected to the connector of the image controlling device; and
a plug mounted to the other end;
wires mounted inside the long pipe and electronically connected between the jack and the plug; and
a plurality of output interface ports mounted outside the long pipe in a line and connected to the corresponding pixel-display string respectively.

3. The scalable LED display system as claim in claim 1, wherein each pixel-display string has multiple display blind modules that are assembled in series, and each display blind module has:
a long casing having:
two opposite ends;
a second plug mounted to one of the ends of the long casing;
a second jack mounted to the other end of the long casing and used to connect to the corresponding output interface port of the top beam or the jack of the other display blind module; and
a printed circuit board mounted inside of the long casing and electronically connected between the second jack and the second jack;
a plurality of LED units mounted on the printed circuit board; and
a controlling circuit mounted on the printed circuit board inside the long casing and electronically connected to the plurality of LED units.

4. The scalable LED display system as claimed in claim 3, further comprising a plurality of rings respectively mounted around a joint between the output interface port and a top display blind module of the pixel-display string.

5. The scalable LED display system as claimed in claim 4, further comprising multiple rings respectively mounted around and between adjacent the display blind modules of each pixel-display string.

6. The scalable LED display system as claimed in claim 1, further comprising a reinforce fixer to support a bottom end of multiple parallel pixel-display strings.

7. The scalable LED display system as claimed in claim 3, wherein each LED unit has multiple light emitting diode chip with different colors.

8. The scalable LED display system as claimed in claim 3, wherein each controlling circuit has a microprocessor, an EEPROM, an I/O and control logic unit, multiple controlling signal pins, power pins, output ports and four control pins.
